(19) United States
(12) Patent Application Publication
(10) Pub. No.: US 2005/0013653 A1
(43) Pub. Date: Jan. 20, 2005

(54) Self-closing ring binder

(76) Inventor: Stephen Eun Chin, Los Angeles, CA (US)

Correspondence Address: STEPHEN EUN CHIN, 752 N. HUDSON AVE. #5, LOS ANGELES, CA, 90038, US

(21) Appl. No.: 10/621,856

(22) Filed: Jul. 16, 2003

(51) Int. Cl. B42F 13/00

(52) U.S. Cl. 402/26

(57) ABSTRACT

The SELF-CLOSING RING BINDER relates to a binding mechanism comprising of opening bars, ring posts and base plate. The opening bars are attached to one leg of each ring posts and are designed to be connection parts to the other legs of the corresponding ring posts. In order to keep the opening bars closed between the legs of ring posts, the retaining force of metal springs and/or magnetism are employed. The retain springs are placed at the connection points between the opening bars and a leg of ring posts, and enable the openings bars closed automatically and anchored at the leg of corresponding ring posts. The magnetic may be pasted at both adjoining sides of the opening bars and the legs of ring posts, which help the opening bars contacted to the corresponding legs of ring posts. This binding mechanism is embodied on the cover.

### CROSS-REFERENCE TO RELATED APPLICATIONS

Not Applicable

### STATEMENT REGARDING FEDERALLY SPONSORED R & D

Not Applicable

### REFERENCE TO SEQUENCE LISTING, A TABLE, OR A COMPUTER PROGRAM LISTING APPENDIX

Not Applicable

### BACKGROUND OF THE INVENTION

In the typical ring binder, the knob(s) is to be pushed to have space at each centers of rings in order to insert perforated papers and documents through the openings. And the knob(s) is to be pulled to close the rings after inserting the papers to secure filing. Representative examples of typical ring assemblies showing one or more these features are: U.S. Pat. No. 1,634,125; U.S. Pat. No. 4,368,995; U.S. Pat. No. 6,270,279; and U.S. Pat. No. 6,511,244. An improved method has been studied for having easier open/close the ring openings, minimized actions to file and more secured stack of papers and documents. In order to accomplish these ideas, the self-closing bars located at the center of each ring posts, the retaining forces of metal springs and/or magnetism are employed, which eliminate the push/pull knob(s) appeared in typical ring binders.

### BRIEF SUMMARY OF THE INVENTION

The claimed invention of Self-Closing ring Binder refers to the ring binder for filing perforated papers, documents, etc., and has characteristics in the self-closing bars at the center of each ring posts of the binder. The mechanism is consisted of opening bars, ring posts, metal springs, magnetic, holding pins and base plate. The opening bars are attached to one leg of each ring posts and work as the bridges to the other leg of the corresponding ring posts.

At each ring posts, the opening bar closed between the legs of a ring post by the retaining force of spring and/or magnetism. The spring is located at the connection point between the opening bar and the leg of a ring post, which enables the bar closed automatically at the other leg of corresponding rign post which performs as the anckor for holding the opening bar. The magnetic are pasted at both adjoining sides of the opening bar and the contacting leg of ring post, which help the opening bar upheld in the ring. The holding pin is used to combine the opening bar, the metal spring and the one leg of ring post in a package and to fasten the parts in secure.

When perforated papers and documents push to insert through the rings, the opening bars are opened automatically and closed either automatically by spring's retaining force or manually by hand when only magnetic are employed. The retaining forces of metal springs and/or magnetism together with centered opening bars enable the paper filing process easier, simpler, and more secure than the typical ring binder.

To construct the claimed invention of Self-Closing Ring Binder, metal and/or suitable rigid plastic materials are used with carrying at least one ring, preferably three rings. The rings may have any suitable forms, which may be a ring proper, a rectangular ring, a D-like ring or the like. The binder is embodied on the cover by using suitable means, such as screws, bolts, nails, rivets, and glue.

The cover of binder may be made of a suitable rigid plastic material, such as polypropylene, polyethylene etc., or from a cardboard, or from a cardboard covered with a suitable plastic foil material, such as PVC, polypropylene, polyethylene etc.

The claimed invention eliminates the open/close knob(s) for having open space at the center of rings to file perforated papers and documents. Only one step of pushing the opening bars by the perforated papers is necessary to file and to secure documents in the binder.

### BRIEF DESCRIPTION OF THE VIEWS OF THE DRAWINGS

The claimed invention is illustrated with reference to the accompanying drawings, wherein:

FIG. 1a shows a perspective views of Self-Closing Ring Binder with built in projection, wherein the binder is embodied on the central part of the cover;

FIG. 1b shows a perspective views of Self-Closing Ring Binder with built in projection, wherein the binder is embodied on one lateral part of the cover;

FIG. 2a shows cross section of a ring of the binding mechanism shown in FIG. 1a;

FIG. 2b shows cross section of a ring of the binding mechanism shown in FIG. 1b;

FIG. 2c shows top view of a ring shown on FIGS. 2a and 2b;

FIG. 3a shows a perspective view of opening bar located at the center of ring shown in FIG. 2a;

FIG. 3b shows a perspective view of opening bar located at the center of ring shown in FIG. 2b;

FIG. 4 shows a perspective view of retaining spring placed at the connection point between opening bar and one leg of ring post;

FIG. 5 shows a perspective view of holding pin to fasten opening bar, spring and a leg of ring post together.

FIG. 6 shows a perspective view how the opening bar, retaining spring and holding pin constructed to ring post.

### DETAILED DESCRIPTION OF THE INVENTION

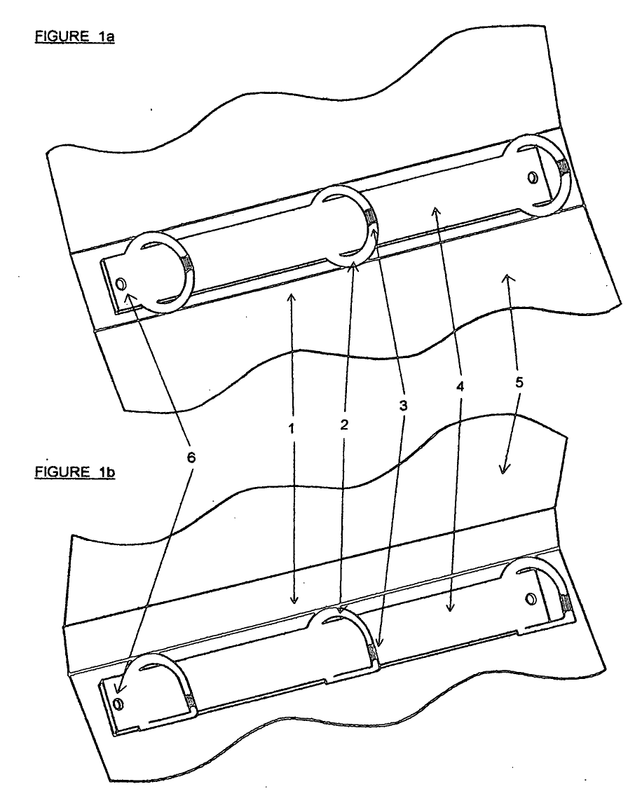

As shown in FIGS. 1a and 1b, ring binder mechanism 1 constructed in accordance with the descriptions of this invention comprises ring posts 2, opening bars 3 and base plate 4. While three ring posts are shown in the drawings, the number of ring is not essential to the invention, provided that at least one pair of ring is present.

The ring binder mechanism 1 is usually located within a cover 5 as shown on FIGS. 1a and 1b. The base plate 4 is affixed to the back of cover 5 by rivets 6 or glue. The base plate 4 and ring posts 2 are constructed of slightly resilient and strong material by molding as a whole or by welding ring posts 2 at the base plate 4.

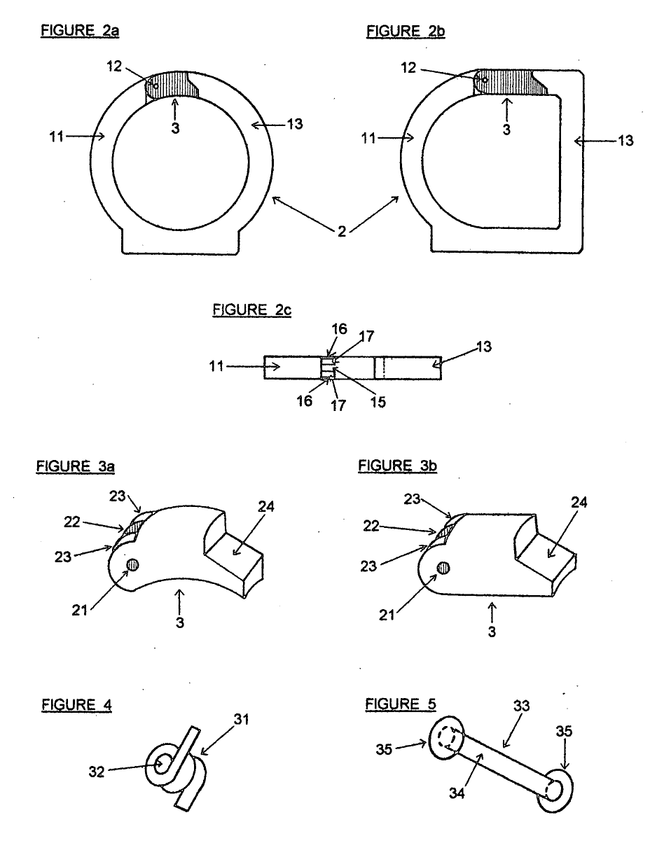

The shape of ring post 2 may have any suitable forms, which may be a ring proper as shown on FIG. 2a, a rectangular ring as shown on FIG. 2b. One leg 11 of ring post 2 has hole 12, room 15 for retain spring 31, concave 16 to sit the leg 23 of opening bar 3 and legs 17 to hold the opening bar 3. The holes 12 and 21 are made at a suitable point, preferably the middle of the width of leg 11 and opening bar 3, to move the opening bar 3 smoothly and freely. The other leg 13 of ring post 2 is cut inner diagonally and flatted to stop the opening bar 3, on where a magnetic may be glued on. The ring posts 2 are constructed of slightly resilient and strong material and can be molded by metal or suitable plastic, or welded on the base plate 4 when only metal is used.

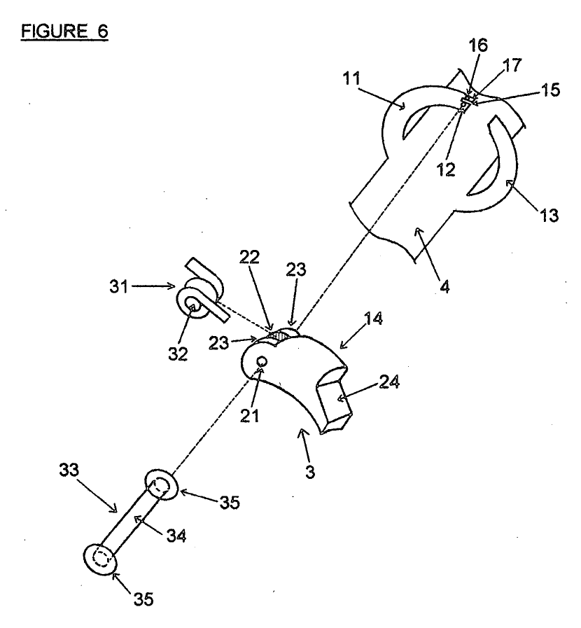

The opening bars 3 as shown on FIGS. 3a and 3b are used to make up the gap between the legs 11 and 13 of each ring post 2 and to be formed to travel the perforated papers smoothly. One side of the opening bar has hole 21 to secure holding pin 33 as shown on FIG. 5, space 22 to custody retain spring 31 and legs 23 to be tied with one leg 11 of the ring post 2. The other side 24 of opening bar 3 is cut outer diagonally and flatted to be stopped by the leg 13 of the ring post 2, on where a magnetic may be glued on. The opening bars 3 are constructed of slightly resilient and strong materials and are molded by metal or suitable plastic, or folded by sheet metal.

The retaining spring 31 shown on FIG. 4 is constructed by steel wire having sufficient force to hold back the opening bar 3 to the corresponding leg 13 of ring post 2. It has also feathering tension to accept the pushing force of a few perforated papers. The retaining spring 31 is coiled at the center to accept the holding pin 33 and placed at the middle 15 of one leg 11 of ring post 2 and space 22 of opening bar 3.

The holding pin 33 as shown on FIG. 5 is constructed of strong material to be riveted or screwed. The size 34 of pin 33 is slightly smaller than the holes of 12, 21 and 32 in order to the corresponding parts combined and worked properly. The head 35 of the holding pin 33 is slightly larger than the holes of 12, 21 and 32 to sustain the holding pin 33 at the leg 11 of ring post 2.

The opening bar 3, retaining spring 31 and holding pin 33 are assembled to ring post 2 as show on FIG. 6. These parts are aligned through the holes 21, 12 and 32 of respective parts at a leg 11 of ring post 2 and enable the opening bar 3 bridged to the other leg 13 of corresponding ring post 2.

While the principles of the invention have been described above in connection with specific apparatus and applications, it is to be understood that this description is made only by way of example and not as a limitation on the scope of the invention.

1. A ring binder with self-closing ring mechanism which is comprised of a opening bar, a holding pin and a retaining spring and/or magnetic at each ring of the binder.

2. A self-closing ring mechanism according to claim 1, wherein the opening bar is anchored by the corresponding leg of ring post by utilizing any suitable form, such as diagonal and/or convex surface at adjoining point.

3. A self-closing ring mechanism according to claim 1, wherein the opening bar is formed suitable for the perforated papers to travel smoothly in the rings, such as arc, straight and etc. in conformity with the shape of corresponding leg of ring post.

4. A self-closing ring mechanism according to claim 1, wherein the magnetic are pasted on both adjoining faces between opening bar and corresponding leg of ring post.

5. A self-closing ring mechanism according to claim 1, wherein the retaining spring possesses sufficient force to hold back the opening bar as well as feathering tension to accept the pushing force of a few perforated papers.

6. A self-closing ring mechanism according to claim 1, wherein the holding pin is made by any suitable means and forms such as rivet, screw and etc.
